(19) United States
(12) Patent Application Publication
(10) Pub. No.: US 2006/0040026 A1
(43) Pub. Date: Feb. 23, 2006

(54) Horizontal mold for edible products

(76) Inventor: William J. Herbert, Kent, OH (US)

Correspondence Address: BROUSE MCDOWELL LPA, 388 SOUTH MAIN STREET, SUITE 500, AKRON, OH, 44311, US

(21) Appl. No.: 10/923,098

(22) Filed: Aug. 21, 2004

(51) Int. Cl. A23G 3/02

(52) U.S. Cl. 426/512

(57) ABSTRACT

A horizontal mold for edible products is provided.

This utility patent application claims priority from provisional patent application, Ser. No. 60/496,452 filed Aug. 19, 2003, which is incorporated herein by reference.

### I. BACKGROUND OF THE INVENTION

A. Field of Invention

This invention pertains to the art of methods and apparatuses for the preparation of frozen products and more particularly to methods and apparatuses for preparing edible foods in complex shapes using a horizontal mold with or without the use of a handle.

B. Description of the Related Art

It is well-known to use molds to make frozen edible food products, such as, Popsicles™, push-ups, ice cream bars, and other various types and shapes of frozen treats. Other food products, such as chocolate candies, may also be formed using molds. Often such food products are used in combination with a handle that is typically referred to as a “stick.” On example is the well known Popsicle™ stick. In use, the handle or stick is held by the user while the food product is eaten off of the stick.

Generally, the molds used in making food products are oriented vertically. This permits the food product, typically in a liquid or semi-liquid state or heated to a liquid or semi-liquid state, to be poured or forced into the open top of the mold. One end of a stick is then placed vertically into the food product within the mold with the second end of the stick extending upward and out of the food product. As the food product cools within the mold, it adheres to the first end of the stick. When the food product has cooled sufficiently and it is desired to remove it from the mold, the second end of the stick is grasped by a user and the food product is pulled upwardly and out of the mold.

Vertical molds work well for their intended purpose. In fact, one advantage of a vertical mold is that there is no need for any type of fluid seal between the mold and the stick. A fluid seal is not required because during the time the food product is in a liquid or semi-liquid state, the stick extends upwardly and generally vertically out of the food product. As a result, there is no chance for the food product to flow relative to the stick or the mold. For this reason, the food product fluid levels can be easily controlled and leakage around the stick is not an issue.

Vertical molds, however, have an important disadvantage. The disadvantage is that simple vertical molds severely limit the types and complexities of shapes that the food products can be molded into. As a result, vertical molds are used to form relatively simple shaped food products or the vertical molds are themselves made complex using, for example, hinged components. More specifically, once the food product liquid has frozen or otherwise hardened into the food product shape in a vertical mold, it is not possible to remove a complex, non-drafted shape from the mold unless the vertical mold has two halves that open horizontally to release the molded complex shape.

An example of a commercial device using vertical molds is provided in U.S. Pat. No. 4,699,583. FIGS. 2, 3a, 3b, and 4 show simple one piece vertical molds that produce frozen shaped food products on a stick that can be vertically removed from the mold. It should be noted that the molds provided here are useful only to provide relatively simple shapes, as shown, to the food product.

U.S. Pat. No. 6,565,902 describes a mold and method for manufacturing a frozen confectionary. This patent teaches the use of complex hinged, vertical molds to produce complex shapes with sticks extending from both ends of the frozen confection. A permanent sealing member in the bottom of the mold is used to prevent fluid leakage.

US patent application Pub. No. 2004/0076727 teaches a method and system for molding ice cream novelties using flexible silicone rubber molds that are “peeled” away from the molded shape. One embodiment, shown in FIGS. 2a and 2b of Pub. No. 2004/0076727, uses a horizontal mold with stick relief's or stick insert openings to produce a simple ice cream pop on a stick. However, the method and system provided are only useful with a food product in a semi-solid state when it is forced into the mold. When the food product is in a semi-solid state, there is minimal leakage around the stick and no seal around the stick is required. As a result, this method and system will not work effectively with food products in a liquid or semi-liquid state when added to the mold because such liquids will leak out of the mold, around the stick. Moreover, the food product of this patent application, which is ice cream, is demolded at a minimum temperature of −10° F. by forcibly peeling the silicone mold away from each individual shape. As a result, this method and system would not work effectively with food products having shapes with intricate appendages because such appendages would be damaged during the forcible demolding.

It is also known in the art, as shown in FIG. 14, to provide a silicone mold tray 500 having horizontal molds 502 with stick openings 504 intended to permit a stick to be inserted through each stick opening 504 and into each mold 502. Such known devices, however, do not provide an adequate seal between the stick and the stick opening. As a result, the food products that can be used with such a device are limited to semi-liquids such as frozen ice cream. The present invention provides methods and apparatuses for a simple horizontal mold that permits more complex shapes to be used in making food products from liquids. The present invention is simple in design and overcomes the aforementioned limitations of known vertical and horizontal molds. Additionally, the horizontal mold and seal of this invention permits the stick placement to be in the proper plane with the horizontally molded shape. The difficulties inherent in the art are therefore overcome in a way that is simple and efficient, while providing better and more advantageous results.

### II. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a view of two users holding a frozen food product with relatively complex shapes made in accordance with this invention.

FIG. 2 is a drawing similar to FIG. 1 showing the same users eating the frozen product.

FIG. 3 is a top view of a mold tray having multiple molds.

FIG. 4 is an end view of the mold tray shown in FIG. 3.

FIG. 5 is a sectional view taken along the lines 5-5 of FIG. 3.

FIG. 6 is a sectional view taken along the lines 6-6 of FIG. 3.

FIG. 7 is a sectional view taken along the lines 7-7 of FIG. 3.

FIG. 8 is an end view of a first embodiment insert.

FIG. 9 is a side view of the insert shown in FIG. 8.

FIG. 10 is a top view of the insert shown in FIG. 8.

FIG. 11 is an end view of a second embodiment insert.

FIG. 12 is a top view of the insert shown in FIG. 11.

FIG. 13 is a sectional view taken along the lines 13-13 shown in FIG. 11.

FIG. 14 is a perspective side view of a prior art silicone mold tray.

### III. DESCRIPTION OF THE PREFERRED EMBODIMENT

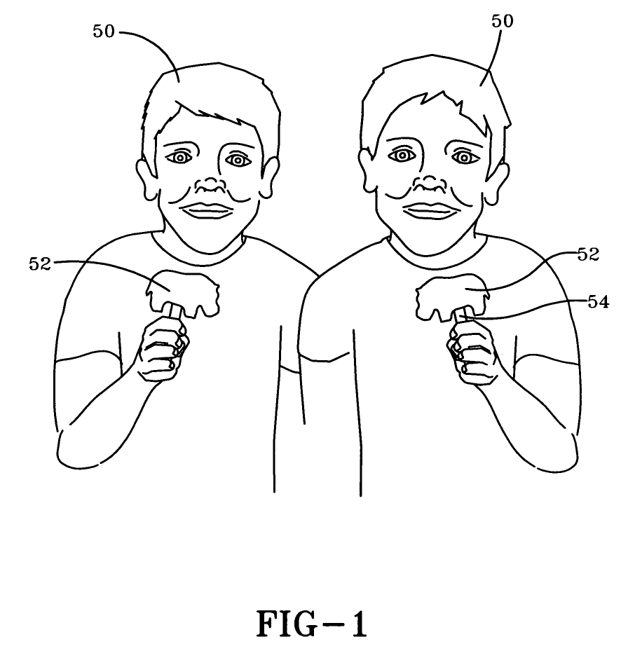

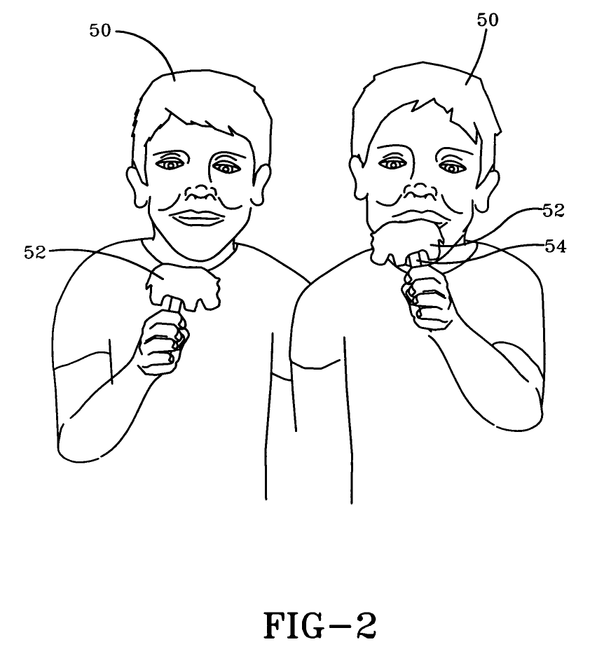

Referring now to the drawings wherein the showings are for purposes of illustrating a preferred embodiment of the invention only and not for purposes of limiting the same, FIGS. 1 and 2 show two users 50 each holding a food product 52 that has a relatively complex shape (complex animal shapes formed of ice cream shown) formed according to the horizontal molding process of this invention. It should be noted that such complex designs for food products produced by horizontal molds are currently unknown in the field of art. Each food product 52 extends from a handle or stick 54 that is held by the users 50.

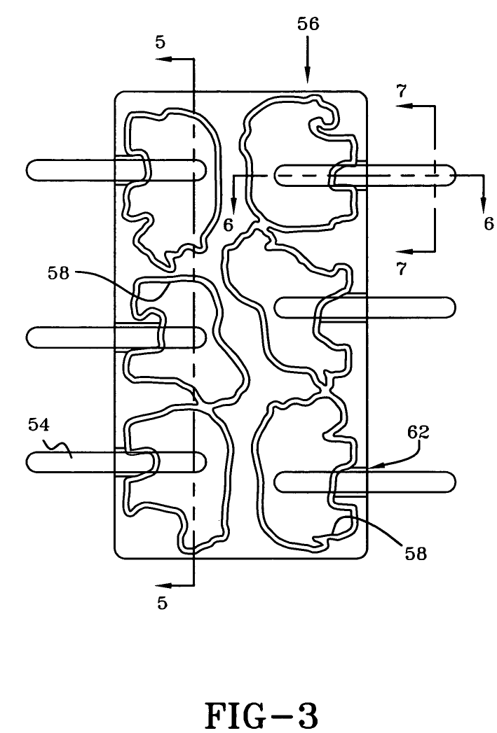

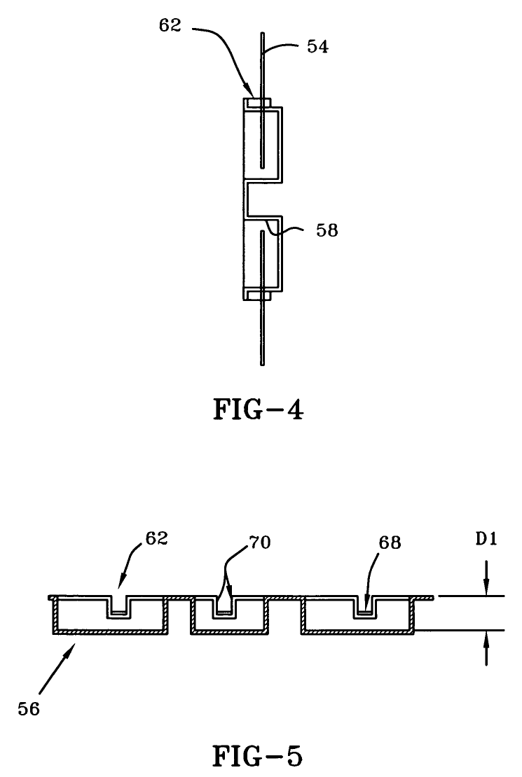

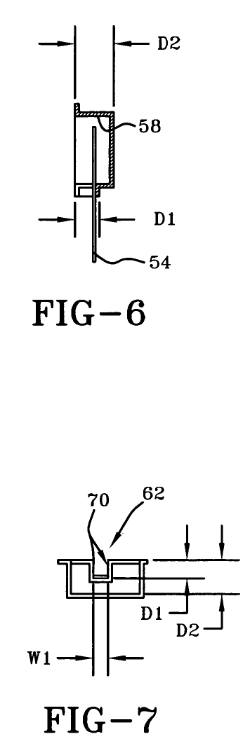

With reference now to FIGS. 1-7, food product 52 having a complex shape like that shown in FIGS. 1 and 2 may be made using a mold tray 56 according to this invention. FIGS. 3-7 show a mold tray 56 that includes six individual molds 58 that are horizontally oriented. A cover plate (not shown) but sized to cover all the molds 58 on the mold tray 56 may also be used. Each mold 58 may have, as shown, a different shape. It is also contemplated that the shapes could be identical or that some could be identical while others vary. All such combinations work equally well with this invention. It should also be noted that while six molds 58 are shown on one mold tray 56, any number of individual molds chosen with sound engineering judgment could be used on a single mold tray 56.

With reference now to FIGS. 3-7, the molds 58 (and thus mold tray 56) can be formed of any material chosen with sound engineering judgment. However, a high thermal conductivity metal, such as aluminum, is preferred. Such a high thermal conductivity metal permits optimum demolding of frozen products (such as ice cream) no matter what the shape of the frozen food product 52. By “demolding” it is meant the removal of the food product 52 from the mold 58. Frozen ice cream shapes are known to be especially difficult to demold as compared to water based frozen goods, such as, frozen pop type fluids. Thus, plastic molds 58 can be used with this invention but in general the demolding process may be longer and more difficult depending on the thermal conductivity of the mold material used. It is also contemplated that the molds 58 and/or mold tray 56 may be formed having a coating, such as fluoropolymer or silicone, to further aid in demolding.

With continuing reference to FIGS. 3-7, preferably each horizontal mold 58 has a channel 62 positioned on the side of the mold 58. Each channel 62 is intended to receive a stick 54 that can be inserted through the channel 62 and into the mold 58 so that the stick 54 will attach to the food product 52 as the food product 52 hardens. Each channel 62 is preferably U-shaped having a bottom surface 68 and a pair of side surfaces 70 spaced apart by a width W1. In the preferred embodiment, the bottom surface 68 has a depth D1 that is at least equal to one half of the mold 58 depth D2. In this way, the stick 54 can be received in the vertical middle of the food product 52. By “vertical middle” it is meant the vertical mid-portion of the food product 52 when the food product 52 is on its side as when being formed in a horizontal mold 58. This vertical middle placement of the stick 54 relative to the food product 52 provides for increased stability and is generally thought to provide a more visually pleasing appearance. Using such a channel 62 appears to create a leakage problem for cases when the food product 52 is a liquid or semi-liquid when inserted into the mold 58 since the liquid food product 52 would seemingly flow around the stick 54 and through the channel 62. This invention, however, provides a way to limit if not eliminate such potential leakage.

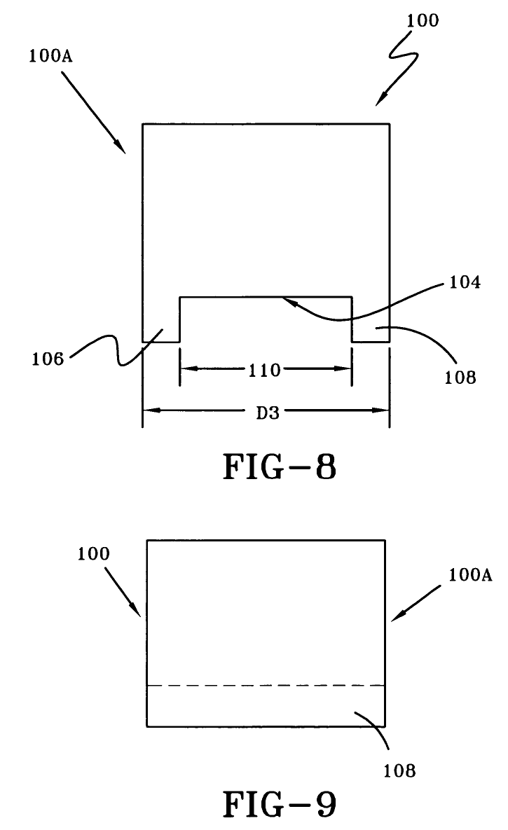

With reference now to FIGS. 8-13, an insert 100 is positioned within the channel 62 to provide a fluid seal for the channel 62. When a stick 54 is to be used with the food product 52, the insert 100 also provides a fluid seal around the stick 54. Preferably, the insert 100 is made of a flexible elastomer. More preferably, the insert 100 is made of an elastomer having a low surface tension, such as silicone rubber, since fluids do not easily “wet” the surface of a silicone elastomer. By a wet surface it is meant a surface that tends to accept or adhere to water. As is well known in the art, low surface tension materials, such as fluoropolymers and silicone rubber, form high contact angles with water and therefore tend to repel water due to the high contact angles between those materials and water. To further improve the sealing characteristics of the insert 100, it has been discovered that coating the bottom surface 68 and side surfaces 70 of the channel 62 with a fluoropolymer or silicone coating having a low surface tension will further reduce or eliminate fluid leakage.

With reference now to FIGS. 8-10, two insert design embodiments are contemplated. The first embodiment insert 100A is shown in FIGS. 8-10. As shown, the insert 100A has a generally rectangular cross section having a width D3 that is substantially equal to the channel width W1. Extending from a first side 104 of the insert 100A is a pair of legs 106, 108. The insert 100A is inserted into the channel 62 with the legs 106, 108 extending downwardly toward the bottom surface 68 of the channel 62. The legs 106, 108, first side 104 of the insert 100A, and bottom surface 68 of the channel 62 combine to form a slot 110 that receives a stick 54. Preferably, the slot 110 has a width and thickness substantially the same as the width and thickness of the stick 54.

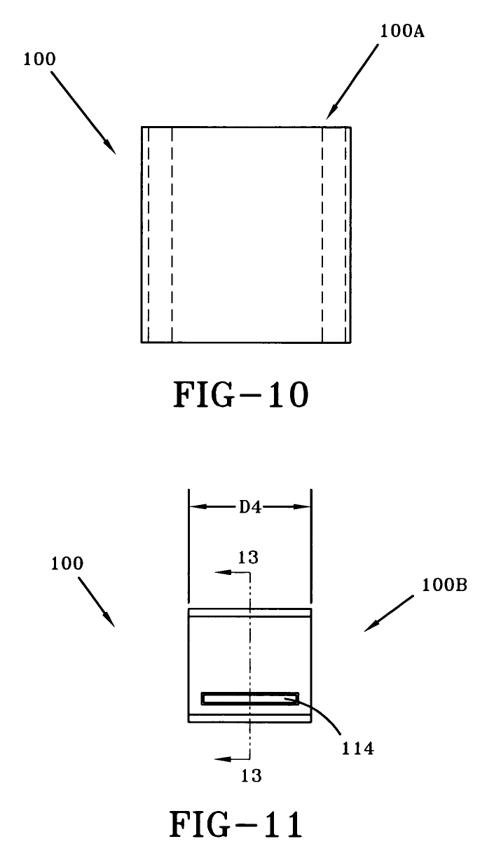

With reference now to FIGS. 11-13, a second embodiment insert 100B is shown. As shown, the insert 100B has a generally rectangular cross section having a width D4 that is substantially equal to the channel width W1. An opening 114 is formed in the insert 100B and is intended to receive a stick 54. Preferably, the opening 114 has a width and thickness substantially the same as the width and thickness of the stick 54. It is also preferred that the opening 114 is formed near the bottom of the insert 100B, when inserted into the channel 62, so that the stick 54 will be received in the vertical middle of the food product 52. Insert removal means 116 is preferably provided so that the insert 100B can be easily removed from the stick 54 once the stick 54 and food product 52 are removed from the mold 58. In the preferred embodiment shown, the insert removal means 116 is a slit 118 that extends from the opening 114 all the way through to an outer surface of the insert 100B.

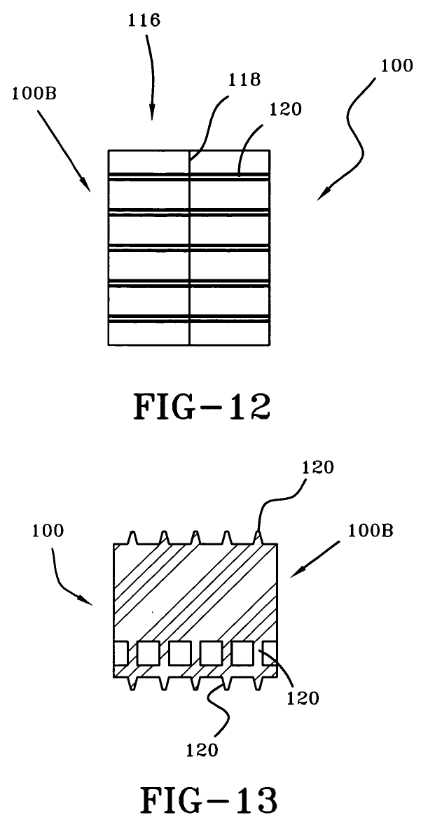

With reference now to FIGS. 8-13, to further improve the sealing characteristics of any of the inserts 100A, 100B described above, at least one ridge 120 may extend from any surface of the insert 100A, 100B that contacts either the mold 58 or the stick 54. It has been discovered that each ridge 120 used provides a separate sealing point to prevent fluid leakage. As a result, it is preferred that multiple ridges 120 are provided, as shown with the second embodiment insert 100B in FIGS. 12-13. While the actual orientation of the ridges 120 can be any chosen with sound engineering judgment, in the preferred embodiment each ridge 120 is oriented substantially perpendicular to the axis of insert 100A, 100B and thus substantially perpendicular to the axis of the channel 62. Depending on the forces exerted by the various components during molding and the materials used to form the various components, the ridges 120 may not be necessary. When, for example, the mold 58 is formed of aluminum, it is not necessary for the insert 100A, 100B to include ridges 120 on the surfaces that contact the side surfaces 70 of the channel 62. If however, the mold 58 is formed of a less sturdy material, such as plastic for example, it may be preferred for the insert 100A, 1000B to include ridges 120 on the surfaces that contact the side surfaces 70 of the channel 62. The ridges 120 have proven to be especially beneficial on the insert surfaces that come into contact with a stick 54 due to the wide manufacturing tolerances of commercially available sticks 54. Table No. 1 summarizes fluid sealing test results using a broad range of dimensionally sized sticks with the second embodiment insert 100B shown in FIGS. 11-13. A result of “Pass” indicates that the combination of insert 100B with ridges 120, stick 54 and channel 62 provided sufficient sealing to prevent leakage of a liquid food product when placed into a mold 58.

TABLE NO. 1
Stick Fluid Sealing Results With Water

| Stick Dimensions-Width × Thickness (inches) | |
|---|---|
| Width (inches) × Thickness (inches) | Results |
| .375 × .075 | Pass |
| .368 × .065 | Pass |
| .376 × .100 | Pass |
| .360 × .082 | Pass |
| .392 × .080 | Pass |

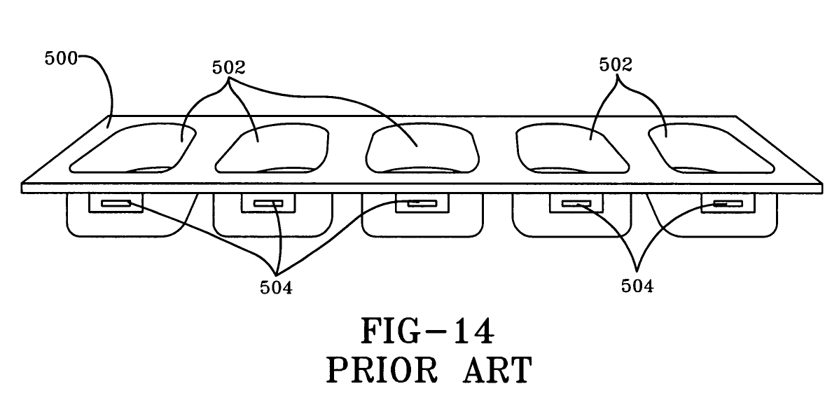

With reference to FIG. 14, it is also contemplated that the leakage problem in the prior art silicone mold tray 500 would be greatly minimized if the inventive ridges 120, described above, were added to the inner surfaces of the stick openings 504. With this embodiment, a separate insert is not required but a proper seal can be formed with the stick despite the known range in commercially available stick dimensions.

With reference now to FIGS. 3-13, to make a food product 52 with a stick 54 according to this invention when used with a mold tray 56 formed of a hard substance, such as metal, the user 50 first sets the mold tray 56 down on a flat surface. The stick 54 is then placed in proper position relative to the insert 100A, 100B and the insert 100A, 100B is inserted into the channel 62 of the mold 58. The proper position of the stick 54 relative to the insert 100A, 100B depends on the desired length of stick 54 to be extended into the mold 58. Alternatively, the insert 100A, 100B can first be inserted into the channel 62 and the stick 54 can then be extended into the slot 110 or opening 114 and into the mold 58. In either case, the stick 54 can be adjusted relative to the insert 100A, 100B as necessary to position the stick 54 as desired within the mold 58. As explained above, the insert 100A, 100B effectively seals the stick 54 within the channel 62.

With continuing reference to FIGS. 3-13, the food product 52 to be molded is then placed into the mold 58. If ice cream is being used, ice cream of any common type or flavor may be taken out of the freezer and placed in a room temperature condition for five or ten minutes to allow it to soften a little bit. The softened ice cream (or other food product) can then be placed within the mold 58. If the food product 52 is in a fluid state, it can simply be poured into the mold 58. If the food product 52 is in a semi-fluid state a tool such as a spoon may be used to force the food product into the mold 58. If the mold 58 is formed of a material having sufficient heat capacity and thermal conductivity, the food product will easily melt (if not already a liquid) into the shape of the mold 58. The process just described is repeated for as many molds 58 as will be used. Next, the cover plate is placed over top of the mold tray 56. The cover plate serves to protect the food product 52 within the molds 58. The mold tray 56 with cover plate is then placed into a freezer. After a sufficient time, say two to three hours, the food product 52 within each mold 58 will have hardened into the desired frozen product and will have the desired shape.

Still referring to FIGS. 3-13, to remove a frozen (or otherwise hardened) food product 52 from a hard mold 58, the user 50 first removes the mold tray 56 from the freezer, and preferably lets the mold tray 56 set at room temperature for a short time (two to three minutes, for example). This time at room temperature permits the frozen product 52 to begin to melt around the edges of each molded shape. The cover plate is then removed. Next, the food product 52 is removed from the mold 58, preferably by grasping and lifting the stick 54, which is now attached to the food product 52 and the insert 100A, 100B, out of the channel 62. Finally, the insert 100A, 100B is removed from the stick 54. If the first embodiment insert 100A has been used, the stick 54 is easily removed from the pair of legs 106, 108. If the second embodiment insert 100B has been used, the stick 54 is again easily removed by opening the insert 100B at the slit 118 and lifting the stick 54 away. This completes the demolding of the food product 52 and makes the food product 52 available to be enjoyed, as shown in FIGS. 1 and 2.

With continuing reference to FIGS. 14 and 15, to make a food product 52 with a stick 54 according to this invention when used with a mold tray 56 formed of a softer substance, such as silicone rubber, the user first removes the food product 52, such as ice cream, from the freezer. The food product 52 is then permitted to become soft for easy molding. The sticks 54 are then inserted through the mold openings containing internal ridges and are then positioned relative to the mold 58 as described above. The softened food product 52 can then be forced into the molds 58 and smoothed. Smoothing can be done using a spoon, table knife, or small spatula. Alternately, the food product 52 can be poured into the mold 58. The mold tray 56 can then be placed into the freezer until the food product 52 has fully frozen to a sufficiently hard state. The mold tray 56 is then removed from the freezer and allowed to thaw around the edges of the frozen food product. To remove the food product 52 from the mold 58, the stick 54 is held tight and lifted or pushed through the mold stick opening and the silicone rubber mold tray 56 is pulled away from the food product 52.

Still referring to FIGS. 3-13, in another embodiment, it may be desired to make a food product 52 without a stick 54. In this case, the method just described can be use with four important distinctions. First, no stick 54 is used. The second distinction is that the insert 100A, 100B is inverted, that is turned upside down as compared to the orientation with a stick 54, to place the pair of legs 106, 108 or opening 114 at the top of the channel 62. It should be noted that either the first or second embodiment 100A, 100B insert can be used without a stick 54. Third, the molds 58 should only be filled to the height of the opening 114 in the insert 100A, 100B. The fourth distinction concerns how the food product 52 is removed from the mold 58. In one embodiment, the mold tray 56 may be turned upside down to permit the food product 52 to gradually slip out of the mold 58. In another embodiment, a stick 54 may be used to urge the food product 52 out of the mold 58 by placing an end of the stick 54 against the food product 52 through the channel 62. This completes the demolding of the food product 52 and makes the food product 52 available to be enjoyed.

It is also contemplated that this invention could be packaged as a kit for individual purchase—including at least one mold tray, at least one insert for each mold on the tray, a cover and a set of instructions. It is also contemplated that this invention could be used in a manufacturing setting where the frozen products are made in a factory and then sold individually or in a package of two or more. This invention works well in either situation.

It is also contemplated that the horizontal molds of this invention could also be used with non-frozen products including, but not limited to, baked goods and chocolate.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

1. A device comprising:
a single piece horizontal mold adapted to mold edible shapes with or without sticks; and,
elastomeric seals adapted to seal the stick and mold side openings from fluid leakage.

2. The device of claim 1, wherein the horizontal mold is made from a high thermal conductivity material, such as aluminum or steel.

3. The device of claim 1, wherein the horizontal mold is made from a high thermal thermal conductivity material, such as aluminum or steel and has a fluoropolymer or silicone coating applied.

4. The device of claim 1, wherein the horizontal mold is made from a low thermal conductivity material, such as plastic or rubber.

5. The device of claim 1, wherein the elastomeric seal has internal and external legs to enhance stick and mold insert sealing with fluids.

6. The device of claim 1, wherein the elastomeric seal is made from silicone rubber or other elastomer with low surface tension.

7. A device adapted to produce frozen, baked, or cast edible products comprising:
a single piece horizontal mold of silicone rubber adapted to mold edible shapes with or without sticks with a molded in seal for sticks that utilizes internal ridges in the stick opening area for effectively sealing a broad variety of fluids.

8. The process of making frozen food shapes on or off sticks using the device of claim 1.

9. The process of making baked food shapes on or off sticks using the device of claim 1.

10. The process of making chocolate food shapes on or off sticks using the device of claim 1.

11. The process of making frozen food shapes on or off sticks using the device of claim 7.

12. The process of making baked food shapes on or off sticks using the device of claim 7.

13. The process of making chocolate food shapes on or off sticks using the device of claim 7.

14. A method of molding a food product comprising the steps of:
providing a horizontal mold having a channel that communicates with the mold;
providing sealing means adapted to seal a stick within the channel;
extending a stick through the sealing means and into the horizontal mold;
placing food product into the horizontal mold;
permitting the food product to harden within the horizontal mold; and,
removing the stick and food product from the horizontal mold.

15. The method of claim 14 wherein the step of providing sealing means adapted to seal a stick within the channel, comprises the step of:
providing an insert that provides a seal with the channel and with the stick.

16. The method of claim 14 wherein the step of extending a stick trough the sealing means and into the horizontal mold, comprises the step of:
extending the stick through a plurality of ridges extending from the surface of the sealing means.

17. The method of claim 16 wherein the step of providing sealing means adapted to seal a stick within the channel, comprises the step of:
providing the sealing means with the capacity to seal sticks ranging in width between 0.300 and 0.400 inches and ranging in thickness between 0.060 and 0.100 inches.
